(19) United States
(12) Patent Application Publication
(10) Pub. No.: US 2024/0038981 A1
(43) Pub. Date: Feb. 1, 2024

(54) LOW OXYGEN RELEASE ELECTRODES

(71) Applicant: FORD GLOBAL TECHNOLOGIES, LLC, Dearborn, MI (US)

(72) Inventors: Christine Kay Lambert, Dearborn, MI (US); Eunsung Lee, Novi, MI (US); Kyungjin Park, Northville, MI (US); Chi Paik, Grosse Ile, MI (US)

(21) Appl. No.: 17/875,357

(22) Filed: Jul. 27, 2022

(51) Int. Cl. H01M 4/525; H01M 4/505; H01M 10/0525; H01M 10/0568; H01M 4/36

(52) U.S. Cl. CPC H01M 4/525; H01M 4/505; H01M 10/0525; H01M 10/0568; H01M 4/366; H01M 4/364; H01M 2004/028

(57) ABSTRACT

Electrodes, electrochemical cells having higher threshold oxygen-release energies, and methods of making the same are disclosed. The electrodes may be a nickel-rich cathode with up to 10% of a rare-earth element such as cerium. The rare-earth element may be added by doping during the manufacture of the cathode or by applying a coating on a surface of the cathode.

### TECHNICAL FIELD

The instant disclosure relates to electrochemical cells such as lithium-ion batteries and more specifically, cathodes therein.

### BACKGROUND

Electrochemical cells such as batteries are a primary method of storing energy. For example, many devices including electric vehicles (EVs) and hybrid electric vehicles (HEVs) may use batteries such as lithium-ion batteries.

### SUMMARY

An electrochemical cell including a first and second electrodes with an electrolyte in contact with each of the first and second electrodes is disclosed. The second electrode may be a nickel cathode having at least 50% nickel and at least 2.5% but no more than 10% of a rare-earth element by weight of the cathode such that the second electrode has a higher oxygen-release energy than the same electrode free of the rare-earth element. The rare-earth element may be cerium. In a refinement, the second electrode may have at least 80% nickel and/or at least 5% of the rare-earth element (e.g., cerium) by weight of the second electrode. In yet another refinement, the second electrode may have at least 7.5% of the rare-earth element (e.g., cerium) by weight of the second electrode. In another embodiment, the rare-earth element (e.g., cerium) may be present at 6 to 8% by weight of the second electrode. The electrochemical cell may be a lithium-ion battery such that the electrolyte is configured to transport lithium ions between the first and second electrodes. The electrolyte may include an organic solvent and/or a lithium salt dissolved therein. A vehicle comprising the electrochemical cell described herein is also disclosed.

A cathode assembly comprising an electrode having a lithium metal oxide and a rare-earth element is disclosed. The electrode and/or lithium metal oxide may have at least 80% nickel by weight of the electrode. The rare-earth element may be cerium and may be present in an amount of at least 7.5% but no more than 10% by weight of the electrode such that nickel and cerium are present at a surface of the electrode and increase the threshold release energy for oxygen to at least 90 kJ/mol, or more preferably at least 95 kJ/mol, or even more preferably at least 100 kJ/mol. The cerium may be present in a cathode coating of the cathode. The cathode coating may be present at a thickness of 1 to 100 nm. Alternatively, or in combination, the rare-earth element (e.g., cerium) may be present as a dopant. In a refinement, the nickel may be present in a lithium metal oxide such as nickel-cobalt-manganese, lithium-nickel-cobalt-aluminum, and/or nickel-cobalt-manganese-aluminum. In a variation, the electrode is a cathode configured to be arranged in an electrochemical cell such that the surface of the cathode is configured to facilitate reduction.

A method of making an electrode is also disclosed. The method includes providing a cathode mixture of at least nickel and cobalt precursors, adding one or more rare-earth precursors such as cerium precursors, carrying out co-precipitation of the precursors to form a precipitate, mixing the precipitate with a lithium salt, and forming an electrode having a least 80% nickel and 2.5 to 10% cerium by weight of the electrode. In a refinement, the one or more cerium precursors may include cerium sulfate. In another variation, cerium may be present in an amount of at least 7.5% by weight of the electrode. In yet another refinement, the one or more cerium precursors may include a plurality of different cerium precursors.

### BRIEF DESCRIPTION OF THE DRAWINGS

FIG. 1 is an electrochemical cell.

FIG. 2 is a cross-section of a first embodiment of an electrode such as for an electrochemical cell.

FIG. 3 is a cross-section of a second embodiment of an electrode such as for an electrochemical cell.

FIG. 4 is flowchart illustrating a method of making an electrode.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. A description of constituents in chemical terms refers to the constituents at the time of addition to any combination specified in the description and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

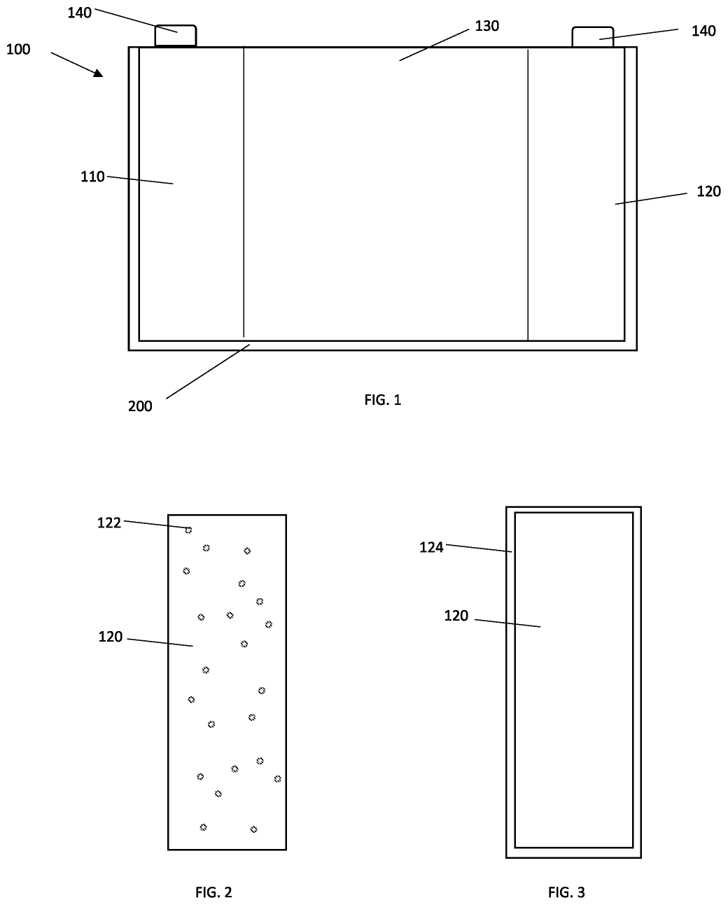

An electrochemical cell 100, as shown in FIG. 1, includes a plurality of electrodes or electrode assemblies such as a first electrode 110 (e.g., an anode), a second electrode 120 (e.g., a cathode) and an electrolyte 130 therebetween and/or in contact with the electrodes 110, 120. The electrochemical cell 100 may also include a current collector 140 and a separator between the anode 110 and cathode 120. The electrochemical cell 100 may be lithium-ion traction battery such as in a vehicle. In the lithium-ion battery (LIB), lithium ions that move between the electrodes through the electrolyte 130. The electrochemical cell 100 may be housed in a housing 200 is not particularly limited and may be any suitable shape and size. The cell 100 may have a prismatic or pouch structure.

The electrodes 110, 120 may be made of any suitable materials such as but not limited to carbon, nickel, lithium, aluminum, and/or oxides thereof. In a refinement, the electrodes 110, 120 may include an intercalated lithium compound and/or graphite. For example, the first electrode 110 may be any suitable anode material such as graphite and the second electrode 120 may be a nickel (Ni) rich cathode.

For example, the second electrode 120 may be at least 50% by weight of nickel, or more preferably at least 60%, or even more preferably at least 65%, or even more preferably at least 75%, or still more preferably at least 80%. In a refinement, the second electrode 120 may be greater than 80% by weight of nickel. The second electrode 120 may be a lithium metal oxide such as a nickel-manganese-cobalt (NMC) material, nickel-cobalt-aluminum (NCA) material, or nickel-manganese-cobalt-aluminum (NMCA) material. In a variation, the second electrode 120 may be or include a material represented by the formula LiNi_{w}MnₓCo_{y}Al_{z}O₂, where the sum of w, x, y, and z is 1. For example, w may be 0.5 and 0.99, or more preferably 0.6 and 0.95, or even more preferably 0.7 and x may be 0 to 0.45, y may be 0.01 to 0.3, and z may be 0 to 0.2 such that no more than one of x, y, and z is simultaneously zero. In a refinement, the cathode 120 may be or include a material represented by the formula LiNiₓMn_{y}Co_{z}O₂, LiNiₓCo_{y}Al_{z}O₂, LiNiₓMn_{w}Co_{y}Al_{z}O₂, or a combination thereof, where the sum of w, x, y, and z is 1 and w is zero when not present. For example, LiNi_{0.33}Mn_{0.33}Co_{0.33}O₂ (NCM 111 or 333) may be used. In a refinement, x may be at least 0.5, or more preferably at least 0.6, or even more preferably at least 0.8. For example, LiNi_{0.5}Mn_{0.3}Co_{0.2}O₂ (i.e., NCM523) may be used, or more preferably LiNi_{0.6}Mn_{0.2}Co_{0.2}O₂ (i.e., NCM622) may be used, or even more preferably LiNi_{0.8}Mn_{0.1}Co_{0.1}O₂ (i.e., NCM811), LiNi_{0.9}Mn_{0.05}Co_{0.05}O₂ (i.e., NCM90), LiNi_{0.8}Co_{0.15}Al_{0.05}O₂, LiNi_{0.885}Mn_{0.100}Co_{0.015}O₂ (i.e., NCA89) LiNi_{0.84}Co_{0.12}Al_{0.04}O₂, or LiNi_{0.89}Co_{0.05}Mn_{0.05}Al_{0.01}O₂ may be used.

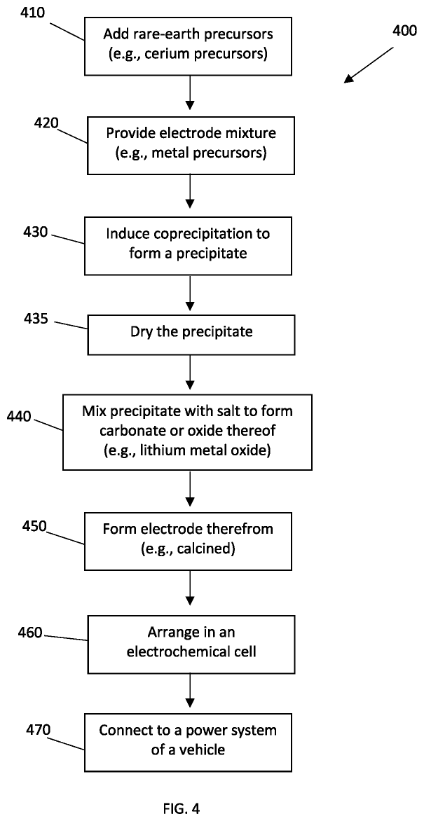

One or more rare-earth elements that have a stronger binding energy to oxygen than nickel may be incorporated in the second electrode 120 as a dopant 122 (as shown in FIG. 3) or a coating 124 (as shown in FIG. 4) such that it raises the threshold/activation energy required to release oxygen from the second electrode 120. For example, the rare-earth element may be added to an amount necessary to achieve a threshold release energy of at least 90 kJ/mol or more preferably 95 kJ/mol or even more preferably at least 100 kJ/mol.

This can reduce the occurrence or acuteness of an undesirable self-heating event because nickel-rich cathodes generally have a lower threshold energy for releasing oxygen under thermal events. For example, one or more rare-earth elements may be added at no less than 1%, or more preferably no less than 2.5%, or even more preferably no less than 5%, or still more preferably no less than 7.5% by weight of the cathode. For example, the one or more rare-earth elements may be added at 10%. In a refinement, the rare-earth elements may be added up to or no more than 10%.

In a refinement, the binding energy or threshold release energy for oxygen may be increased by at least 10%, or more preferably at least 20%, or even more preferably at least 30%, or still even more preferably at least 40% as a result of the dopant 122 or coating 124. In a variation, amount of oxygen released at an oxygen release temperature (e.g., may be at least 10% lower, or more preferably at least 20% lower, or even more preferably at least 30% lower, or still even more preferably at least 40% lower.

In yet another embodiment, the temperature at which oxygen is released may be increased by at least 10° C., or more preferably at least 20° C., or even more preferably at least 30° C.

A differential electrochemical mass spectroscopy (DEMS) can be used to understand the oxygen release amount at different battery states-of-charge, age, and condition. Another method can include a pressure reactor with a defined volume containing the materials described herein. The reactor is fed a known amount of oxygen, and slowly heated, and the responding pressure is read with time.

In a variation, more-available and less expensive rare-earth elements may be used such as cerium (Ce) and lanthanum (La) as opposed to less-available and more expensive rare-earth elements such as Praseodymium (Pr), Neodymium (Nd), Dysprosium (Dy), and Terbium (Tb). In other words, in some embodiments, the second electrode 120 may be free of Praseodymium (Pr), Neodymium (Nd), Dysprosium (Dy), and Terbium (Tb), or have less than 1% by weight or even more preferably less than 0.1%, or even more preferably less than 0.05%. More preferably, the one or more rare-earth elements may include cerium (Ce). For example, cerium (Ce) may be added at 1-10%, or more preferably 3-9%, or even more preferably 6-8%. At loading levels exceeding 10% of the rare-earth element (e.g., cerium) by weight of second electrode 120, energy densities may decrease, and cell poisoning may occur. Alternatively, or in combination with cerium (Ce) and/or lanthanum (La), zirconium (Zr), Barium (Ba), and/or Yttrium (Y) may be used.

The electrolyte 130 may be any suitable material for transporting ions sufficient to facilitate redox reactions that generate electrical energy. In a variation, i.e., a lithium-ion battery (LIB), the electrolyte 130 may be suitable to transport lithium ions (Li t). For example, the electrolyte 130 may include a salt solution, solid electrolyte or polymer electrolyte. A suitable salt solution may include a solvent such as an organic solvent and a lithium salt. In a refinement, a polar solvent such as ethylene carbonate (EC), dimethyl carbonate (DMC), diethyl carbonate (DEC), ethyl methyl carbonate (EMC), and propylene carbonate (PC) or a combination thereof may be suitable. A suitable a lithium salt may be hexafluorophosphate (LiPF₆), LiPF₃(C₂F₅)₃, LiAsF₆, LiClO₄, LiBF₄, LiSO₃CF₃, LiN(SO₂CF₃)₂, LiC(SO₂CF₃)₃, LiBETI, LiBC₄O₈, LiBOB, LiFAP, LiODFB, LiTFSI or a combination thereof.

Referring to FIG. 4, a method 400 of making an EV or HEV is disclosed. The method 400 may include providing an electrode mixture (i.e., step 410) for forming an electrode such as a cathode mixture including nickel, manganese, cobalt, and/or aluminum precursors. In a refinement, the cathode mixture may include at least nickel and cobalt precursors. For example, a nickel, manganese, and cobalt precursors may be used to prepare an NMC electrode and nickel, cobalt, and aluminum precursors may be used to prepare an NCA electrode.

One or more rare-earth precursors may be added to the electrode mixture (i.e., step 420) such as cerium precursors. For example, sulfates, nitrides, carbonates and/or hydroxide precursors may be used. For example, nickel sulfates (Ni(SO₄)), manganese sulfates (Mn(SO₄)), cobalt sulfates (Co(SO₄)), aluminum sulfates (Al₂(SO₄)₃), cerium sulfates (Ce(SO₄)₂, nickel hydroxides (Ni(OH)₂), manganese hydroxides (Mn(OH)₂), cobalt hydroxides (Co(OH)₃), aluminum hydroxides (Al(OH)₃), and cerium hydroxides (Ce(OH)₃) or any combination thereof may be suitable. In a refinement, a plurality of different rare-earth precursors such as cerium sulfate, cerium nitride, cerium hydroxide, cerium chloride, and/or zirconium hydroxide may be used. For example, the combination of cerium sulfate and cerium nitrate may be particularly useful. In yet another example, a cerium hydroxide and zirconium hydroxide precursor hybrid may be used.

Coprecipitation of the precursors is then carried out/induced to form a precipitate (i.e., step 430). The precipitate may then be dried (i.e., step 435) and mixed with a salt to form a carbonate or oxide thereof (i.e., step 440) and calcined to form an electrode (i.e., step 450). For example, the precipitate may be mixed with a lithium salt such as lithium hydroxide or lithium carbonate and calcined to form, e.g., a lithium metal oxide electrode doped with cerium. In a refinement, the nickel precursors may be added at the quantities described herein such 80% nickel by weight of the electrode. The cerium precursors may be added at a quantity such that the cerium is present in the electrode in an amount as disclosed herein, for example, from 6 to 8% by weight of the electrode. Alternatively, or in combination, a lithium metal oxide electrode may be formed and coated with a rare-earth element coating, e.g., cerium coating such that the cerium is present in the amounts described herein.

The electrodes may be assembled in an electrochemical cell (i.e., step 460) as described herein and connected to a power system of a vehicle (i.e., step 470).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electrochemical cell comprising:
a first electrode;
a second electrode having at least 50 wt. % nickel and at least 2.5 wt. % of a rare-earth element but no more than 10 wt. % such that the second electrode has a higher oxygen-release energy than a same electrode free of the rare-earth element; and
an electrolyte in contact with each of the first and second electrodes.

2. The electrochemical cell of claim 1, wherein the rare-earth element is cerium.

3. The electrochemical cell of claim 2, wherein the second electrode has at least 80 wt. % nickel.

4. The electrochemical cell of claim 3, wherein the second electrode has at least 5 wt. % cerium.

5. The electrochemical cell of claim 3, wherein the second electrode has at least 7.5 wt. % cerium.

6. The electrochemical cell of claim 2, wherein the second electrode has 6-8 wt. % cerium.

7. The electrochemical cell of claim 6, wherein the electrolyte is configured to transport lithium ions between the first and second electrodes.

8. The electrochemical cell of claim 7, wherein the electrolyte includes a lithium salt.

9. The electrochemical cell of claim 3, wherein the second electrode is a cathode.

10. A vehicle comprising the electrochemical cell of claim 1.

11. A cathode assembly comprising:
an electrode having a lithium metal oxide with at least 80 wt. % nickel, and at least 7.5 wt. % but no more than 10 wt. % cerium, wherein the nickel and cerium are present at a surface of the electrode such that a threshold-release-energy for oxygen is at least 90 kJ/mol.

12. The electrode of claim 11, wherein the cerium is present in a cathode coating.

13. The electrode of claim 12, wherein the cathode coating is 1 to 100 nm.

14. The electrode of claim 11, wherein the cerium is present as a dopant.

15. The electrode of claim 11, wherein the nickel is present in a lithium metal oxide of nickel-cobalt-manganese, lithium-nickel-cobalt-aluminum, and/or nickel-cobalt-manganese-aluminum.

16. The electrode of claim 11, wherein the surface is configured to facilitate reduction when arranged in an electrochemical cell.

17. A method of making an electrode comprising:
providing a cathode mixture of nickel and cobalt precursors;
adding one or more cerium precursors;
effecting co-precipitation of the precursors to form a precipitate;
mixing the precipitate with a lithium salt; and
forming an electrode having at least 80 wt. % nickel and 2.5 to 10 wt. % cerium.

18. The method of claim 17, wherein the one or more cerium precursors includes cerium sulfate.

19. The method of claim 17, wherein the electrode has at least 7.5% cerium.

20. The method of claim 17, wherein the one or more cerium precursors includes a plurality of different cerium precursors.
